(19) United States
(12) Patent Application Publication
(10) Pub. No.: US 2008/0137177 A1
(43) Pub. Date: Jun. 12, 2008

(54) ELECTROPHORETIC DISPLAY

(75) Inventors: Ho-Yong JUNG, Yongin-si (KR); Cheol-Woo PARK, Suwon-si (KR); Jun-Young LEE, Yongin-si (KR); Sung-Wook KANG, Seoul (KR); Sung-Jin HONG, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/952,764

(22) Filed: Dec. 7, 2007

(30) Foreign Application Priority Data
Dec. 8, 2006 (KR) 10-2006-00124952

(51) Int. Cl. G02F 1/167; G06F 3/041

(52) U.S. Cl. 359/296; 345/173

(57) ABSTRACT

An electrophoretic display includes first and second display substrates that are opposite each other and an electrophoretic layer and a contact sensor interposed between the first and second display substrates. When the second display substrate is pressed, the contact sensor connects a common electrode of the second display substrate with a sensing interconnection of the first display substrate such that a potential difference occurs at the pressed position.

### CROSS-REFERENCE TO RELATED APPLICATION

This application claims priority from and the benefit of Korean Patent Application No. 10-2006-00124952, filed on Dec. 8, 2006, which is hereby incorporated by reference for all purposes as if fully set forth herein.

### BACKGROUND OF THE INVENTION

1. Field of the Invention

The present invention relates to an electrophoretic display. More particularly, the present invention relates to a thin and lightweight electrophoretic display.

2. Discussion of the Background

In general, display apparatuses convert data, which has an electrical format when processed in an information processing unit, into a visible image when displaying the data. One such display apparatus is an electrophoretic display (EPD), which is thinner and lighter than a cathode-ray tube (CRT) display or a liquid crystal display (LCD).

More specifically, an EPD includes lower and upper substrates, each of which has an electrode, and pigment particles interposed between the lower and upper substrates. The pigment particles move toward the lower substrate or toward the upper substrate under the influence of an electric field applied between the lower and upper substrates. In this manner, the charged particles migrate under the influence of the applied electric field, which is referred to as electrophoresis. An EPD displays an image using electrophoresis. Particularly, an EPD is a kind of reflective display that displays an image using external light. Hence, an EPD does not require a separate light source. Since the pigment particles are formed into a very thin layer, an EPD may have reduced weight and thickness.

An EPD may further include a touch panel so that a user can manipulate an information processing unit. When the hand of the user or an object contacts a specific portion of the touch panel, the touch panel detects the contacted position and outputs positional information corresponding to the contacted position. The information processing unit processes data according to an instruction corresponding to the positional information of the contacted position. The use of touch panels in EPDs has increased because a touch panel provides for easier manipulation than a keyboard or a mouse. However, the touch panel is generally mounted over the display panel on which the image is displayed, which increases the thickness of the display apparatus. In addition, the display quality may be deteriorated.

### SUMMARY OF THE INVENTION

The present invention provides an electrophoretic display that may increase user convenience with regard to a touch panel function.

Additional features of the invention will be set forth in the description which follows, and in part will be apparent from the description, or may be learned by practice of the invention.

The present invention discloses an electrophoretic display including a first display substrate, a second display substrate, an electrophoretic layer, and at least one contact sensor. The first display substrate includes a first base substrate, at least one pixel disposed on the first base substrate and to receive a pixel voltage, and at least one sensing interconnection arranged above the first base substrate. The sensing interconnection receives a position detection voltage. The second display substrate includes a second base substrate facing the first base substrate and a common electrode disposed on the second base substrate. The common electrode receives a common voltage. The electrophoretic layer includes a plurality of particles, each of which has a polarity and a predetermined color, interposed between the first and second display substrates. The contact sensor is disposed on the sensing interconnection between the first and second display substrates and spaced apart from one of the first and second display substrates. The contact sensor connects the second display substrate to the first display substrate when the second display substrate is pressed.

The present invention also discloses an electrophoretic display including a first display substrate, a second display substrate, an electrophoretic layer disposed between the first display substrate and the second display substrate, a sensing interconnection, and a contact sensor. The first display substrate includes a pixel, which includes a switching element and a pixel electrode connected to the switching element. The second display substrate includes a common electrode facing the pixel electrode. The sensing interconnection is disposed on the same layer as the pixel electrode and spaced apart from the pixel electrode, and the sensing interconnection receives a position detection voltage. The contact sensor is disposed corresponding to the sensing interconnection and connects the second display substrate to the first display substrate in response to a pressing of the second display substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view showing an electrophoretic display (EPD) according to an exemplary embodiment of the present invention.

FIG. 2 is a sectional view taken along line I-I′ of FIG. 1.

FIG. 3 is a plan view showing another exemplary embodiment of the contact sensor of FIG. 1.

FIG. 4 is a sectional view illustrating yet another exemplary embodiment of the contact sensor of FIG. 1.

FIG. 5 is a sectional view showing an EPD according to another exemplary embodiment of the present invention.

FIG. 6 is a sectional view showing another exemplary embodiment of the contact sensor of FIG. 5.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclose is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

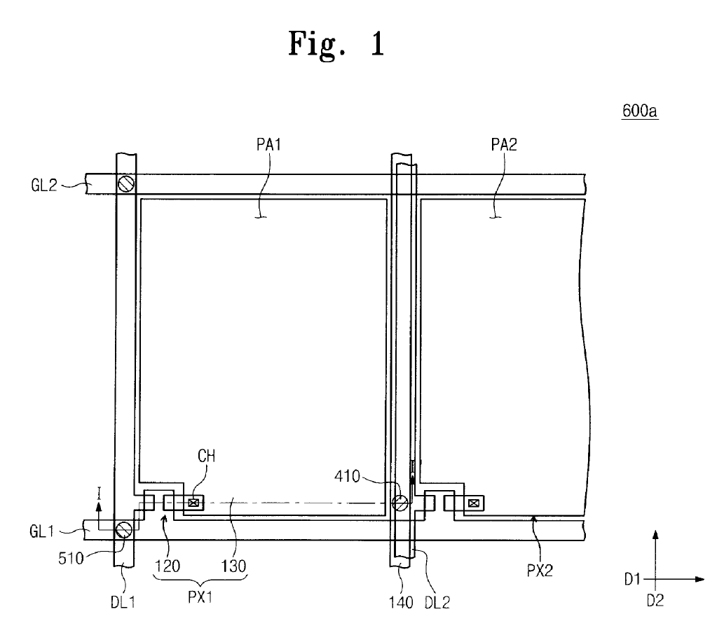

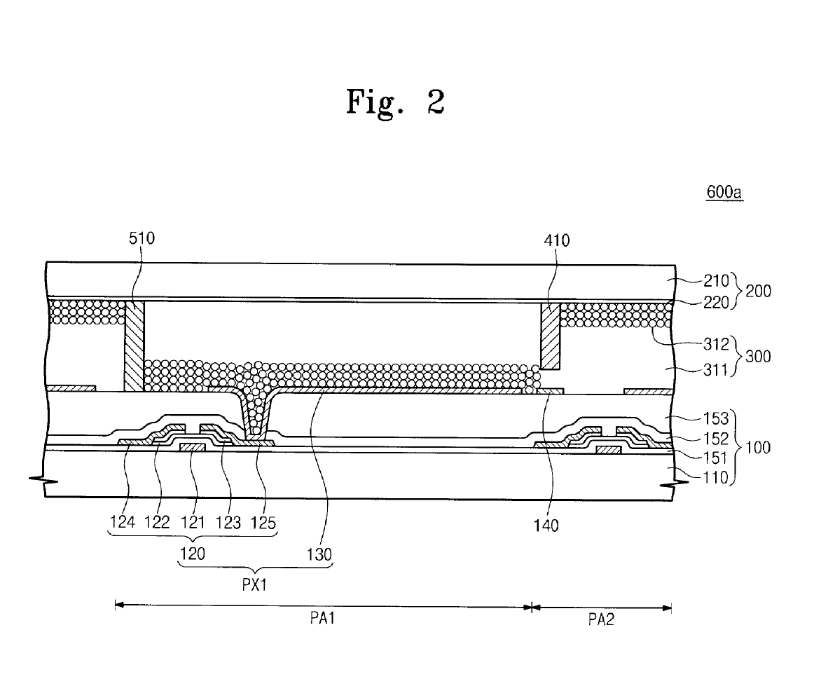

FIG. 1 is a plan view showing an electrophoretic display (EPD) according to an exemplary embodiment of the present invention. FIG. 2 is a sectional view taken along line I-I′ of FIG. 1.

Referring to FIG. 1 and FIG. 2, the EPD 600a includes a first display substrate 100, a second display substrate 200, an electrophoretic layer 300, and at least one contact sensor 410.

The first display substrate 100 includes a first base substrate 110, at least one gate line GL1 and GL2, at least one data line DL1 and DL2, at least one pixel PX1 and PX2, and at least one sensing interconnection 140.

The first base substrate 110 includes a plurality of pixel areas PA1 and PA2, which display an image and is defined in an array arrangement. The pixel areas PA1 and PA2 are defined by gate lines GL1 and GL2 and data lines DL1 and DL2. In an exemplary embodiment of the present invention, the first pixel area PA1 of the pixel areas is defined by the first gate line GL1 and the first data line DL1. The first pixel PX1 is formed in the first pixel area PA1. In this exemplary embodiment, the configurations of the pixels are identical to each other and a pixel is formed in each pixel area.

The first gate line GL1 is formed on the first base substrate 110 and extends in a first direction D1. The first data line DL1 extends in a second direction D2, which is substantially perpendicular to the first direction D1, and crosses the gate lines GL1 and GL2 while being insulated from the gate lines GL1 and GL2. The first pixel PX1 includes a thin film transistor 120 that switches a pixel voltage and a pixel electrode 130 that is supplied with the pixel voltage. The thin film transistor 120 in the first pixel area PA1 includes a gate electrode 121 branching from the first gate line GL1, an active layer 122 and an ohmic contact layer 123 that are sequentially formed above the gate electrode 121, a source electrode 124 that branches from the first data line DL1 and is formed on the ohmic contact layer 123, and a drain electrode 125 formed on the ohmic contact layer 123. The pixel electrode 130 in the first pixel area PA1 is connected to the drain electrode 125 of the thin film transistor 120 in the first pixel area PA1 and is supplied with the pixel voltage.

The first display substrate 100 further includes a gate insulating layer 151, a passivation layer 152, and an organic insulating layer 153. The gate insulating layer 151 is formed on the first base substrate 110 to cover the gate lines GL1 and GL2 and the gate electrodes 121. The passivation layer 152 and the organic insulating layer 153 are sequentially formed on the gate insulating layer 151 and cover the data lines DL1 and DL2 and the thin film transistor 120. Further, a contact hole CH exposing the drain electrode 125 is formed through the passivation layer 152 and the organic insulating layer 153. The pixel electrode 130 is formed on the organic insulating layer 153 and is connected to the drain electrode 125 through the contact hole CH.

The sensing interconnection 140 is formed on the organic insulating layer 153 and is supplied with a sensing voltage so that the position where the sensing interconnection 140 is connected to the second display substrate 200 can be recognized. Further, the sensing interconnection 140 may be formed of a conductive metal material and spaced apart from the pixel electrode 130. In the present exemplary embodiment, the sensing interconnection 140 extends in the second direction D2 and is disposed between two pixels PX1 and PX2 that are adjacent in the first direction D1. Alternatively, the sensing interconnection 140 may extend in the first direction D1. In this case, the sensing interconnection 140 is disposed between two pixels that are adjacent in the second direction D2. Herein, the sensing interconnection 140 may be formed in a row unit or a column unit of the pixel areas. In addition, a predetermined number of row units or column units may be provided.

The second display substrate 200 is disposed above the first display substrate 100. The second display substrate 200 includes a second base substrate 210 and a common electrode 220. The second base substrate 210 faces the first base substrate 110 and may be formed of a flexible material, such as polyethylene terephthalate (PET). The common electrode 220 is formed on the second base substrate 210. The common electrode 220 may be formed of a transparent conductive material, such as indium zinc oxide (IZO) or indium tin oxide (ITO), and is supplied with the common voltage.

The electrophoretic layer 300 is interposed between the first display substrate 100 and the second display substrate 200. The electrophoretic layer 300 displays a predetermined color under the influence of an electric field applied between the pixel electrode 130 and the common electrode 220. The electrophoretic layer 300 includes a fluid layer 311 of a dielectric liquid having a predetermined color and a plurality of particles 312 scattered in the fluid layer 311. Each particle 312 may have a color different from that of the fluid layer 311 and may be charged positively or negatively. The position of each particle 312 changes according to the electric field applied between the pixel electrode 130 and the common electrode 220.

For example, when the particles 312 are negatively charged, a negative potential is formed between the first display substrate 100 and the second display substrate 200. Thus, the particles 312 migrate to the first display substrate 100 so that the color of the fluid layer 311 is displayed. In contrast, when the particles 312 are positively charged, a positive potential is formed between the first display substrate 100 and the second display substrate 200. As a result, the particles 312 migrate to the second display substrate 200 so that the color of the fluid layer 311 is displayed. Here, the potential between the first display substrate 100 and the second display substrate 200 may be independently formed in each pixel area, so that the position of each particle 312 may be set for each pixel area.

A contact sensor 410 is interposed between the first display substrate 100 and the second display substrate 200. The contact sensor 410 is formed on the common electrode 220, connected to the common electrode 220, and may be formed of a transparent conductive material, such as IZO or ITO. Here, the contact sensor 410 may be integrally formed with the common electrode 220. When viewed in a plan view, the contact sensor 410 may have a dot shape, as FIG. 1 shows.

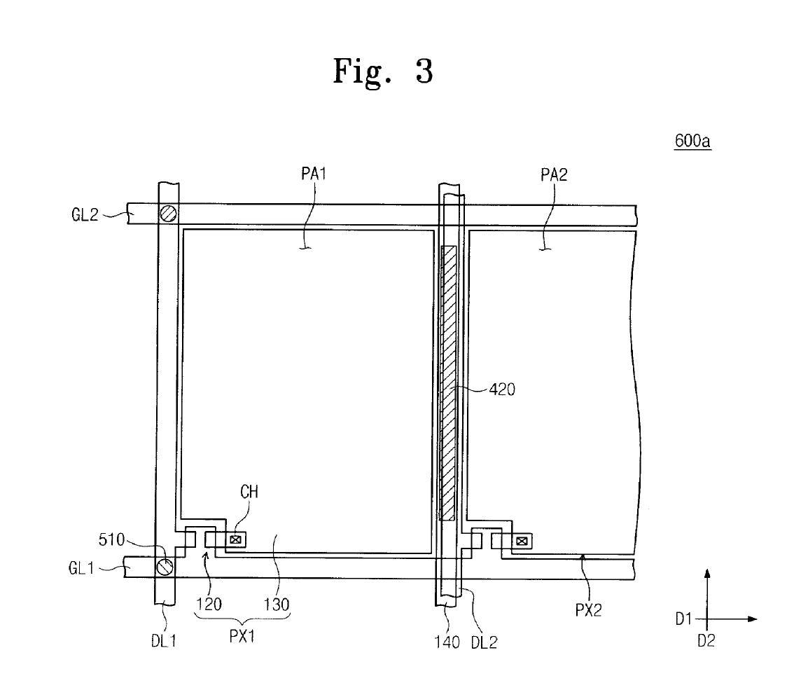

FIG. 3 is a plan view showing another exemplary embodiment of the contact sensor of FIG. 1.

Referring to FIG. 3, the contact sensor 420 according to another exemplary embodiment of the present invention has the shape of a rod when viewed in plan view. As an example, the contact sensor 420 may extend in the second direction D2. Alternatively, the contact sensor 420 may extend in the first direction D1.

Referring to FIG. 1 and FIG. 2 again, the contact sensor 410 is located in an area where the sensing interconnection 140 is formed and is spaced apart from the sensing interconnection 140. When a specific portion of the second display substrate 200 is pressed by a user's hand or an object, the contact sensor 410 contacts the sensing interconnection 140, thereby connecting the common electrode 220 to the sensing interconnection 140.

When the common electrode 220 is connected to the sensing interconnection 140, a potential difference occurs at a position where the common electrode 220 is connected to the sensing interconnection 140. A position sensor (not shown), which is connected to the common electrode 220 and the sensing interconnection 140, detects x and y coordinates of the position where the potential difference occurs and then generates information corresponding to the position where the sensing interconnection 140 is connected to the contact sensor 410. Thus, the EPD 600a may detect a position selected by the user without a separate touch panel, which may reduce the thickness of the EPD 600a, improve user convenience, and improve display quality.

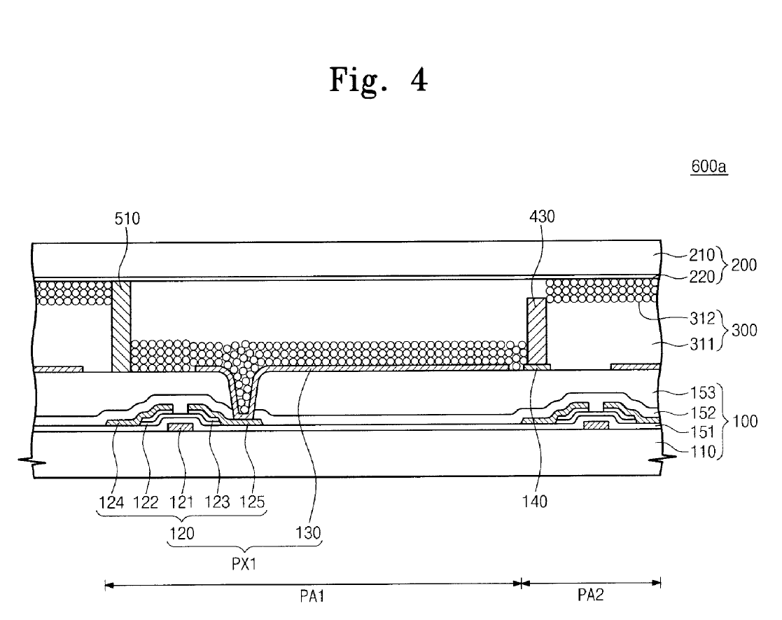

In this exemplary embodiment, the contact sensor 410 is formed on the common electrode 220. Alternatively, the contact sensor 410 may be formed on the sensing interconnection 140, as shown in FIG. 4.

FIG. 4 is a sectional view shown yet another exemplary embodiment of the contact sensor of FIG. 1.

Referring to FIG. 4, the contact sensor 430 according to yet another exemplary embodiment of the present invention is formed on the sensing interconnection 140, connected to the sensing interconnection 140, and spaced apart from the common electrode 220. Here, the contact sensor 430 may be integrally formed with the sensing interconnection 140.

Referring to FIG. 1 and FIG. 2 again, the EPD 600a further includes at least one spacer 510, which is interposed between the first display substrate 100 and the second display substrate 200. Although the contact sensor 410 and the sensing interconnection 140 make contact with each other, the spacer 510 causes the first display substrate 100 to be spaced apart from the second display substrate 200 and to return to their original state thereof. In this exemplary embodiment, the spacer 510 may have the shape of a dot. Alternatively, the spacer 510 may be formed to partially surround each pixel area PA1 and PA2.

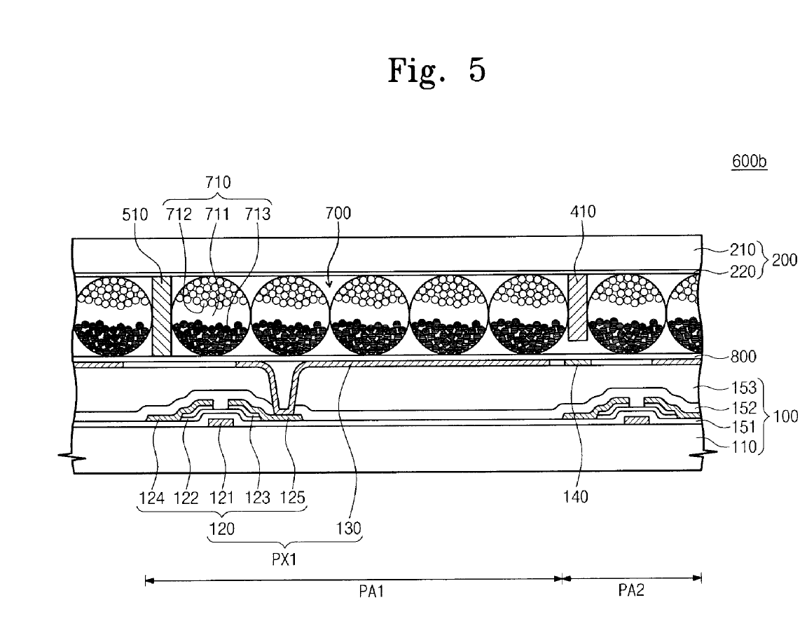

FIG. 5 is a sectional view showing an EPD according to another exemplary embodiment of the present invention.

Referring to FIG. 5, the EPD 600b according to another exemplary embodiment of the present invention has the same configuration as that 600a shown in FIG. 2 except for the electrophoretic layer 700. Thus, in a detailed description of the EPD 600b, the same reference numerals denote the same elements as in the EPD 600a shown in FIG. 2, and thus, detailed descriptions of elements that are the same will be omitted.

The EPD 600b includes a first display substrate 100 supplied with a pixel voltage, a second display substrate 200 supplied with common voltage, and an electrophoretic layer 700 and a contact sensor 410 interposed between the first display substrate 100 and the second display substrate 200.

The electrophoretic layer 700 includes a plurality of microcapsules 710, each of which may have the shape of a sphere. Each microcapsule 710 may have a diameter similar to that of a human hair. Each microcapsule 710 includes a fluid medium 711 of a transparent dielectric liquid and a plurality of first and second particles dispersed in the fluid medium 711. Each first particle 712 and each second particle 713 is charged and has a predetermined color. The first particles 712 are different from the second particles 713 in polarity and color.

In an exemplary embodiment of the present invention, each first particle 712 may be positively charged and may be formed of titanium oxide (TiO₂), thus having a white color. In contrast, each second particle 713 may be negatively charged and may be formed of carbon black, thus having a black color. The positions of the first and second particles 712 and 713 change under the influence of an electric field applied between the first display substrate 100 and the second display substrate 200.

In other words, when a negative potential is formed between the first display substrate 100 and the second display substrate 200, the second particles 713 migrate to the first display substrate 100 and the first particles 712 migrate to the second display substrate 200 so that the color of the first particles 712, i.e. the white color, is displayed. In contrast, when a positive potential is formed between the first display substrate 100 and the second display substrate 200, the first particles 712 migrate to the first display substrate 100 and the second particles 713 migrate to the second display substrate 200 so that the color of the second particles 713, i.e. the black color, is displayed. Here, the potential between the first display substrate 100 and the second display substrate 200 may be independently formed in each pixel area, so that the position of each particle may be set for each pixel area.

Meanwhile, the EPD 600b further includes an adhesive member 800, which adheres the electrophoretic layer 700 to the first display substrate 100. The adhesive member 800 is interposed between the electrophoretic layer 700 and the first display substrate 100 and couples the electrophoretic layer 700 and the first display substrate 100. In the present exemplary embodiment, the electrophoretic layer 700 is integrally formed with the second display substrate 200 so that the electrophoretic layer 700 and the second display substrate 200 may be formed into one film.

A contact sensor 410 is formed on a common electrode 220 and is spaced apart from the sensing interconnection 140 of the first display substrate 100. In this exemplary embodiment, the contact sensor 410 is adapted to be connected to the common electrode 220, but spaced apart from the sensing interconnection 140. Alternatively, the contact sensor 410 may be connected to the sensing interconnection 140.

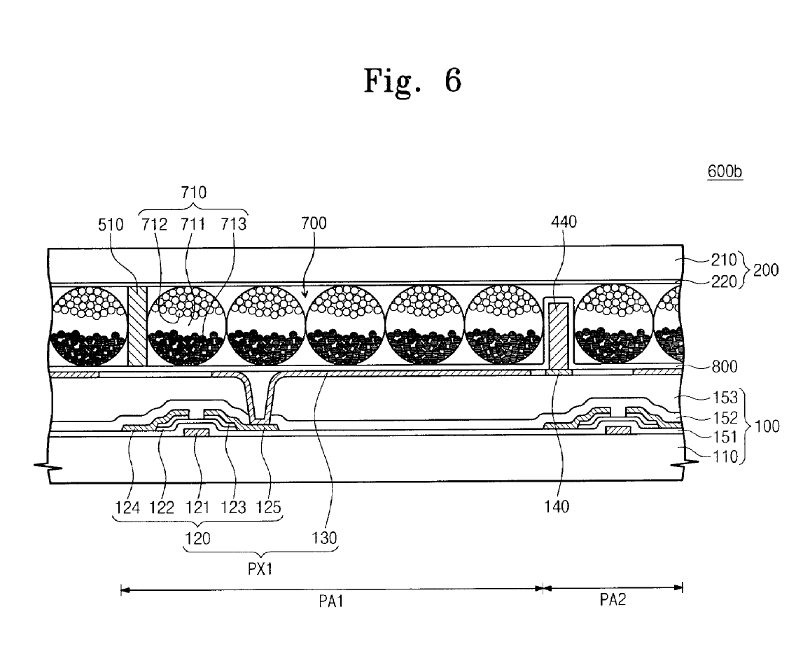

FIG. 6 is a sectional view showing another exemplary embodiment of the contact sensor of FIG. 5.

Referring to FIG. 6, the contact sensor 440 according to another exemplary embodiment of the present invention is formed on the sensing interconnection 140 and spaced apart from the common electrode 220. In this manner, since the contact sensor 440 is integrally formed with the first display substrate 100, the contact sensor 440 is covered by the adhesive member 800.

According to the exemplary embodiments of the present invention described above, the EPD includes a contact sensor, which generates a potential difference by connecting the first and second display substrates while the second display substrate is partially pressed by the manipulation of the user. Thus, the EPD receives an instruction from the user through the contact of a character or figure displayed on a screen without a separate touch panel. Accordingly, the EPD may have a reduced thickness and may improve user convenience as well as display quality.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An electrophoretic display, comprising:
a first display substrate comprising:
a first base substrate,
at least one pixel disposed on the first base substrate and to receive a pixel voltage, and
at least one sensing interconnection arranged above the first base substrate, the sensing interconnection to receive a position detection voltage;
a second display substrate comprising:
a second base substrate facing the first base substrate, and
a common electrode disposed on the second base substrate and to receive a common voltage;
an electrophoretic layer comprising:
a plurality of particles, each of which has a polarity and a color,
the electrophoretic layer being interposed between the first display substrate and the second display substrate; and
a contact sensor disposed on the sensing interconnection between the first display substrate and the second display substrate and spaced apart from one of the first display substrate and the second display substrate, the contact sensor connecting the second display substrate to the first display substrate when the second display substrate is pressed.

2. The electrophoretic display of claim 1, wherein the contact sensor protrudes from the common electrode, is spaced apart from the sensing interconnection, and is connected to the sensing interconnection when the second display substrate is pressed.

3. The electrophoretic display of claim 2, wherein the contact sensor is integrally formed with the common electrode.

4. The electrophoretic display of claim 1, wherein the contact sensor protrudes from the sensing interconnection, is spaced apart from the common electrode, and is connected to the common electrode when the second display substrate is pressed.

5. The electrophoretic display of claim 4, wherein the contact sensor is integrally formed with the sensing interconnection.

6. The electrophoretic display of claim 1, wherein the contact sensor has a dot shape when viewed in a plan view.

7. The electrophoretic display of claim 1, wherein the contact sensor has a rod shape when viewed in a plan view.

8. The electrophoretic display of claim 1, wherein the pixel comprises:
a thin film transistor to switch the pixel voltage; and
a pixel electrode connected to the thin film transistor and to receive the pixel voltage.

9. The electrophoretic display of claim 8, wherein the sensing interconnection is spaced apart from the pixel electrode.

10. The electrophoretic display of claim 1, wherein the contact sensor comprises a transparent conductive material.

11. The electrophoretic display of claim 1, further comprising a spacer interposed between the first display substrate and the second display substrate to allow the first display substrate to be spaced apart from the second display substrate.

12. The electrophoretic display of claim 1, wherein the particles comprise:
first particles that are negatively charged; and
second particles that are positively charged, the second particles having a different color than the first particles.

13. The electrophoretic display of claim 12, wherein the electrophoretic layer comprises a plurality of microcapsules, each of which encapsulates the first particles and the second particles.

14. The electrophoretic display of claim 1, wherein the electrophoretic layer comprises a fluid layer that is encapsulated between the first display substrate and the second display substrate and comprises a liquid, and
wherein the particles are dispersed in the liquid.

15. The electrophoretic display of claim 1, wherein the second base substrate comprises a flexible material.

16. The electrophoretic display of claim 1, wherein the sensing interconnection comprises a conductive metal material.

17. An electrophoretic display, comprising:
a first display substrate comprising a pixel, the pixel comprising a switching element and a pixel electrode connected to the switching element;
a second display substrate comprising a common electrode facing the pixel electrode;
an electrophoretic layer disposed between the first display substrate and the second display substrate;
a sensing interconnection disposed on the same layer as the pixel electrode and spaced apart from the pixel electrode, the sensing interconnection to receive a position detection voltage; and
a contact sensor disposed corresponding to the sensing interconnection, the contact sensor to connect the second display substrate to the first display substrate in response to a pressing of the second display substrate.

18. The electrophoretic display of claim 17, wherein the contact sensor protrudes from the common electrode, is spaced apart from the sensing interconnection, and is connected to the sensing interconnection in response to the pressing of the second display substrate.

19. The electrophoretic display of claim 17, wherein the contact sensor protrudes from the sensing interconnection, is spaced apart from the common electrode, and is connected to the common electrode in response to the pressing of the second display substrate.

20. The electrophoretic display of claim 17, further comprising a spacer interposed between the first display substrate and the second display substrate to allow the first display substrate to be spaced apart from the second display substrate.
